(19) United States
(12) Patent Application Publication
(10) Pub. No.: US 2009/0147026 A1
(43) Pub. Date: Jun. 11, 2009

(54) Graphic zoom functionality for a custom report

(75) Inventors: Schuyler Buck, Muncie, IN (US); Morris J. Young, Indianapolis, IN (US); Jason Bush, Fishers, IN (US); Scott W. Leahy, Fort Wayne, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,932

(22) Filed: Dec. 7, 2007

(51) Int. Cl. G09G 5/00

(52) U.S. Cl. 345/666; 345/660; 345/440

(57) ABSTRACT

The present invention relates to a software zoom feature capable of magnifying data plotted on a graph. The graph may display any type of data including medical data. The graph may also be customizable as to the type of data displayed. The data that is to be magnified by the zoom feature may be selected using a click and drag technique with an input device, such as a mouse, connected to a computer.

### FIELD OF THE INVENTION

The present invention relates generally to the medical device field. Specifically, the present invention relates to software capable of displaying medical information in a custom graph. In addition, the software is capable of magnifying portions of the graph.

### BACKGROUND OF THE INVENTION

Software capable of compiling medical information of a patient is known. For example, prior art software is capable of compiling blood glucose measurements for a patient with diabetes. Generally, the software is also capable of displaying the compiled data on, for example, a computer monitor. The data compiled by some versions of prior art software can be displayed in a fixed graphical format.

### SUMMARY OF THE INVENTION

An embodiment of the invention includes a method of magnifying a portion of a custom graph. The method includes the steps of plotting a first set of data on a graph including a graphing area; selecting a portion of the graph to magnify; and expanding the selected portion of the graph to fill substantially the graphing area.

The method may further include the step of plotting a second set of data on the graph. In addition, the method may include the step of selecting the type of data comprising the second set of data.

In embodiments of the invention, the graph includes an indicator. The indicator indicates whether the graph is highlighting the first set of data or the second set of data. In addition, the graph may include a toggle option for selecting which type of data the graph is highlighting.

In embodiments of the invention, the method includes the step of selecting the type of data comprising the first set of data. The type of data selected to comprise the first set of data may include blood glucose measurements.

The method may include the step of selecting a date range for the data to be plotted on the graph. In embodiments of the invention, the method includes the step of selecting an icon in order to display the first data set in the display area without magnification.

An embodiment of the invention includes a method of displaying a first set of data on a graph including a display area. The method comprises the steps of selecting a date range in order to determine a subset of the first set of data; plotting the subset of the first set of data on the display area; selecting a portion of the display area; and magnifying the selected portion of the display area to fill substantially the entire display area.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIGS. 1 through 12 depict screen captures of software representing embodiments of the present invention;

Although the drawings represent embodiments of various features and components according to the present invention, the drawings are not necessarily to scale and certain features may be exaggerated in order to better illustrate and explain the present invention. The exemplification set out herein illustrates an embodiment of the invention, and such exemplification is not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates. Moreover, the embodiments were selected for description to enable one of ordinary skill in the art to practice the invention.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts descibed herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

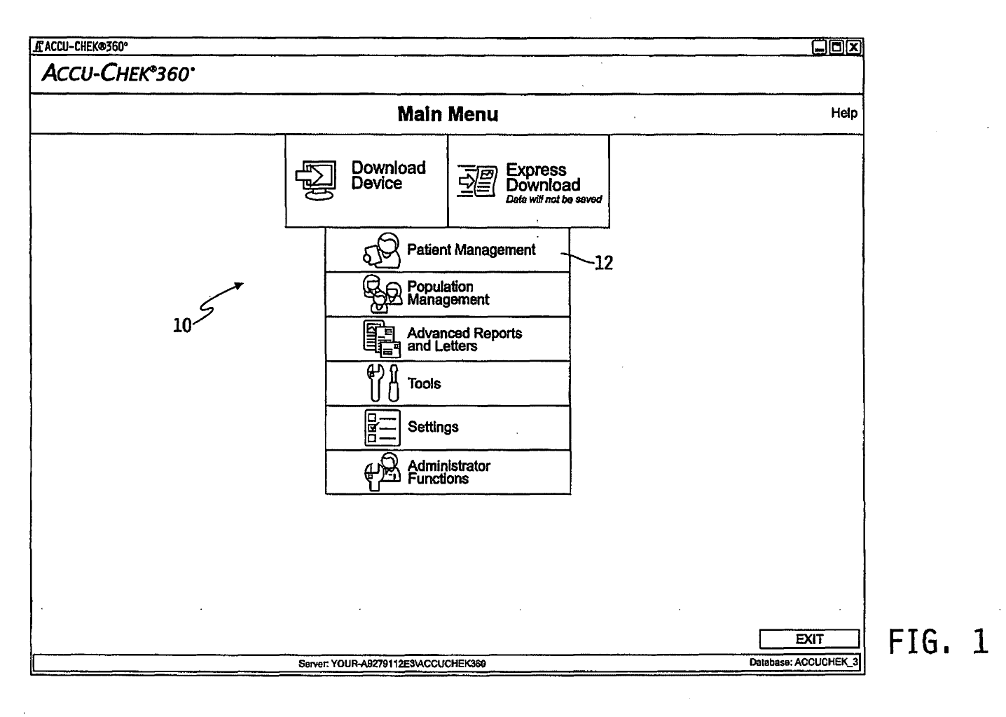

FIG. 1 depicts a screen capture from software entitled ACCU-CHEK® 360° from Roche Diagnostics, which includes features representing embodiments of the present invention. The present embodiment of the invention relates to medical software utilized by users caring for a patient with diabetes. The ACCU-CHEK® 360° software is configured for use with any suitable computer. It should be noted that the invention itself is not limited to medical software, but may be utilized in any field of use. Moreover, although the software is described herein for operation on a computer (e.g., desktop, laptop or tablet), it should be understood that the principles of the invention may be embodied in software for operation on various devices, including but not limited to personal digital assistants (“PDAs”), infusion pumps, blood glucose meters, cellular phones, or integrated devices including a glucose measurement engine and a PDA or cellular device. Finally, it should be understood that the physiological information evaluated by the software of the present invention may include blood glucose values, A1c values, Albumin values, Albumin excretin values, body mass index values, blood pressure values, carbohydrate values, cholesterol values (total, HDL, LDL, ratio) cheatinine values, fructosamine values, HbA1values, height values, insulin dose values, insulin rate values, total daily insulin values, ketone values, micra values, microalbumin values, proteinuria values, heart rate values, temperature values, triglyceride values, and weight values.

With reference still to FIG. 1, numeral 10 generally indicates a main menu. Main menu 10 includes a plurality of menu options, including a patient management icon 12. Patient management icon 12 may be selected in any suitable manner, such as by utilizing a mouse to control the cursor in order to click the patient management icon 12.

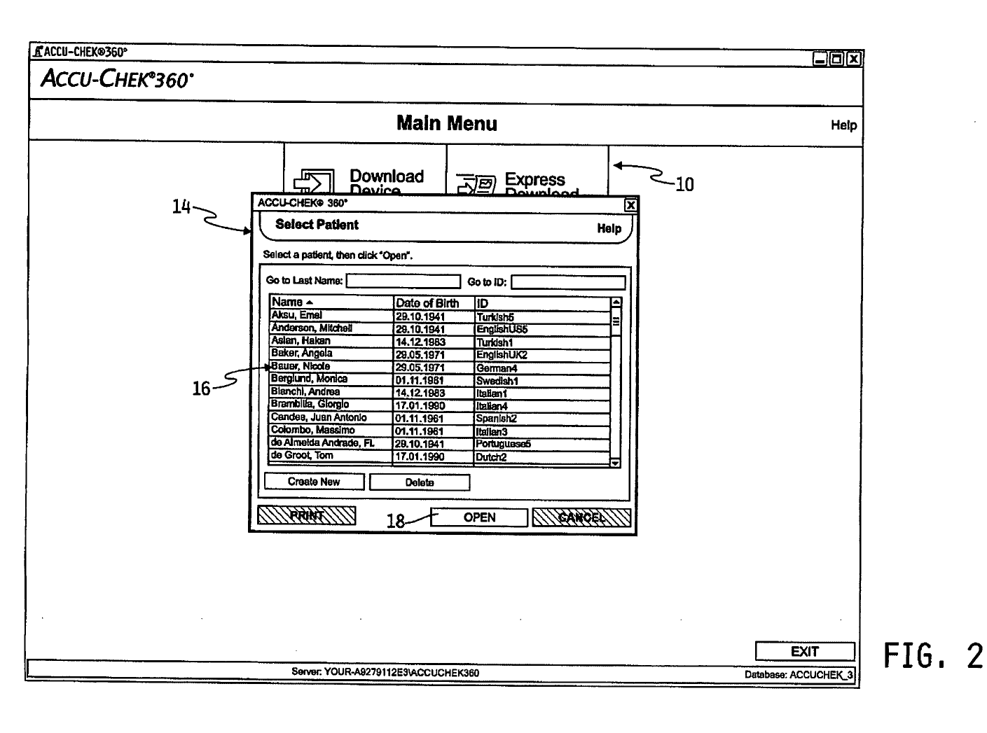

In the present embodiment, clicking the patient management icon 12 causes an interface box, indicated by numeral 14, to open as shown in FIG. 2. Interface box 14 includes a listing of patients. In the present illustration, each of the patients has associated medical data stored in a database which may be entered in any suitable manner. For example, the data may be manually entered into the system by a user. The data may also be transmitted to the system from a suitable diagnostic device capable of measuring blood glucose levels of the patients. In addition to blood glucose values, exemplary medical information includes A1c values, Albumin values, Albumin excretion values, body mass index values, blood pressure values, carbohydrate values, cholesterol values (total, HDL, LDL, ratio) creatinine values, fructosamine values, HbA1values, height values, insulin dose values, insulin rate values, total daily insulin values, ketone values, microalbumin values, proteinuria values, heart rate values, temperature values, triglyceride values, and weight values.

A user, such as a healthcare provider, may select the patient in order to review the data associated with the patient. In the depicted embodiment, a user may review the data of “Emel Aksu” by double clicking his name, or by clicking the name once and then clicking the open icon 18.

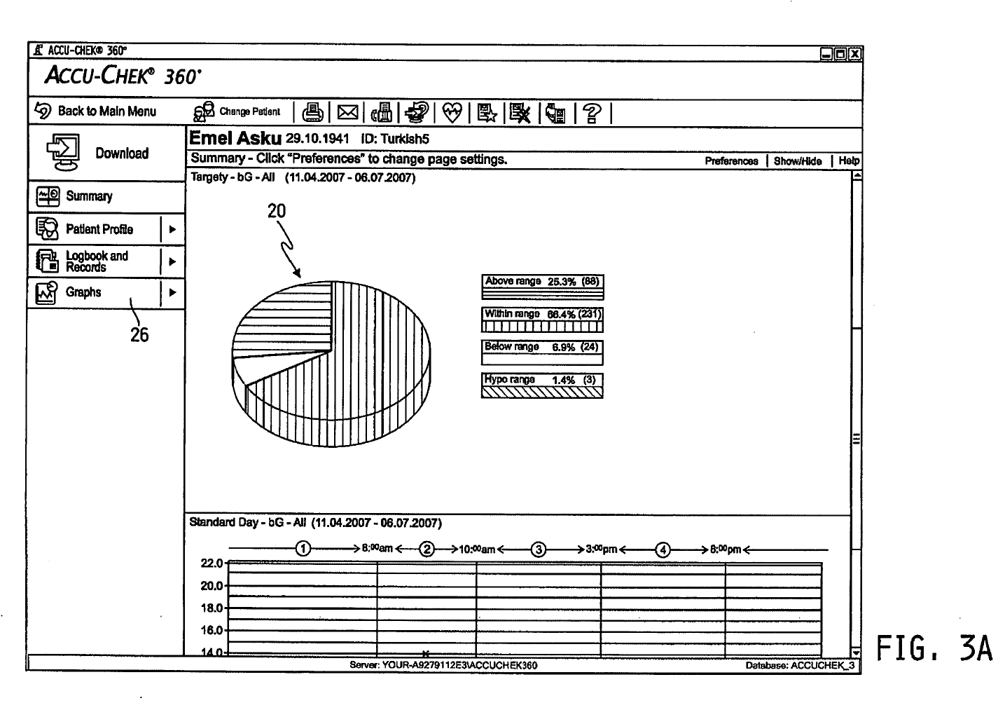

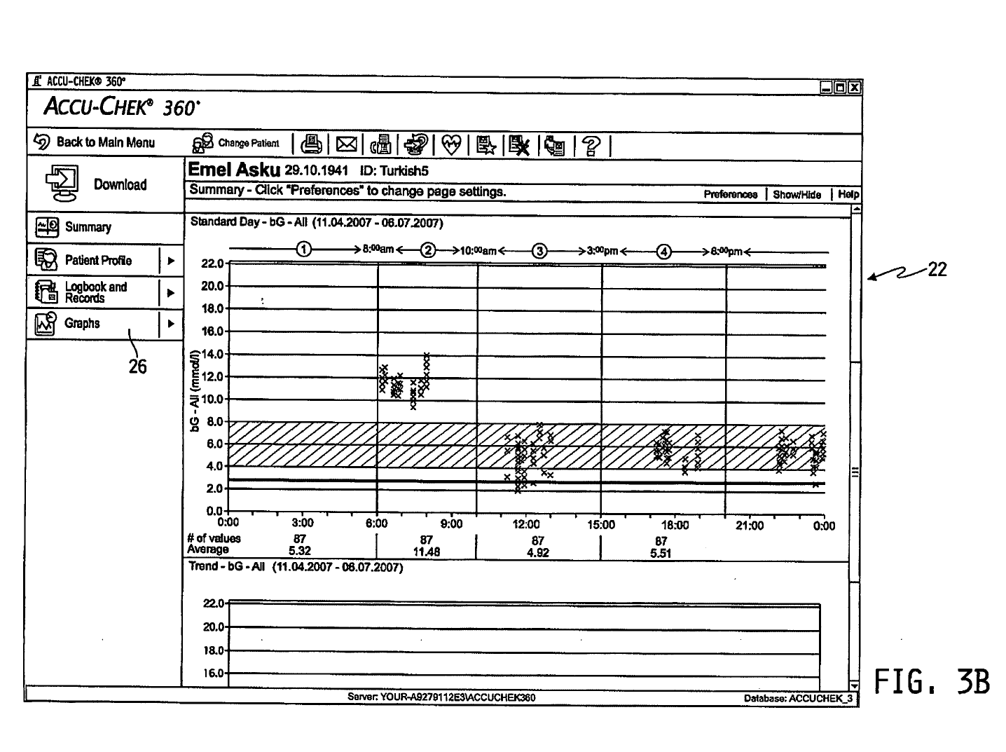

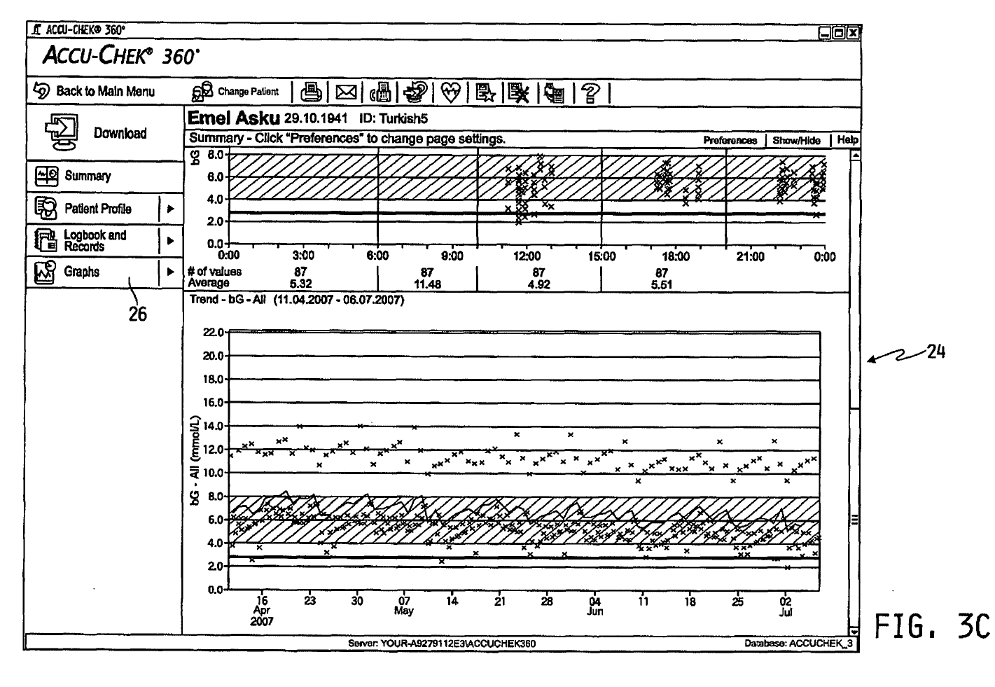

In the present embodiment, once the user selects a patient, the software takes the user to a summary screen depicted in FIGS. 3a through 3c . As seen in FIGS. 3a through 3c , the default summary screen provides a summary of the blood glucose levels of the selected patient, in a pie chart 20, as seen in FIG. 3a , and scatter graphs 22, 24, as seen in FIGS. 3b and 3c , respectively.

In the event a user would like to further review the medical information associated with the selected patient, the user may select the graphs icon 26, in any suitable manner.

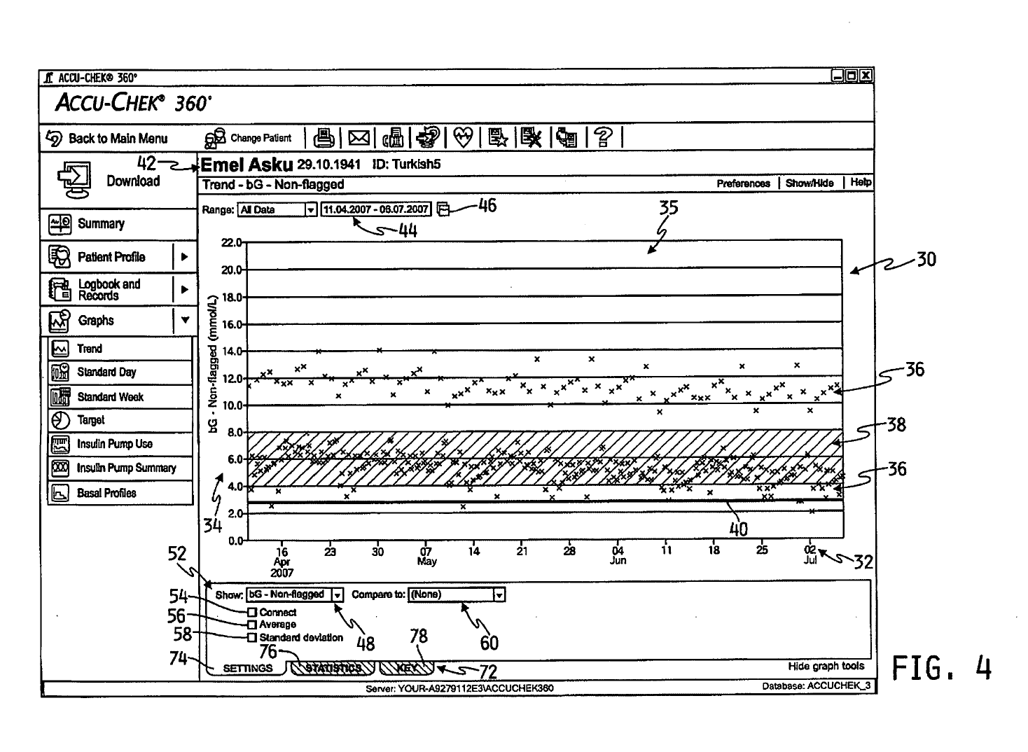

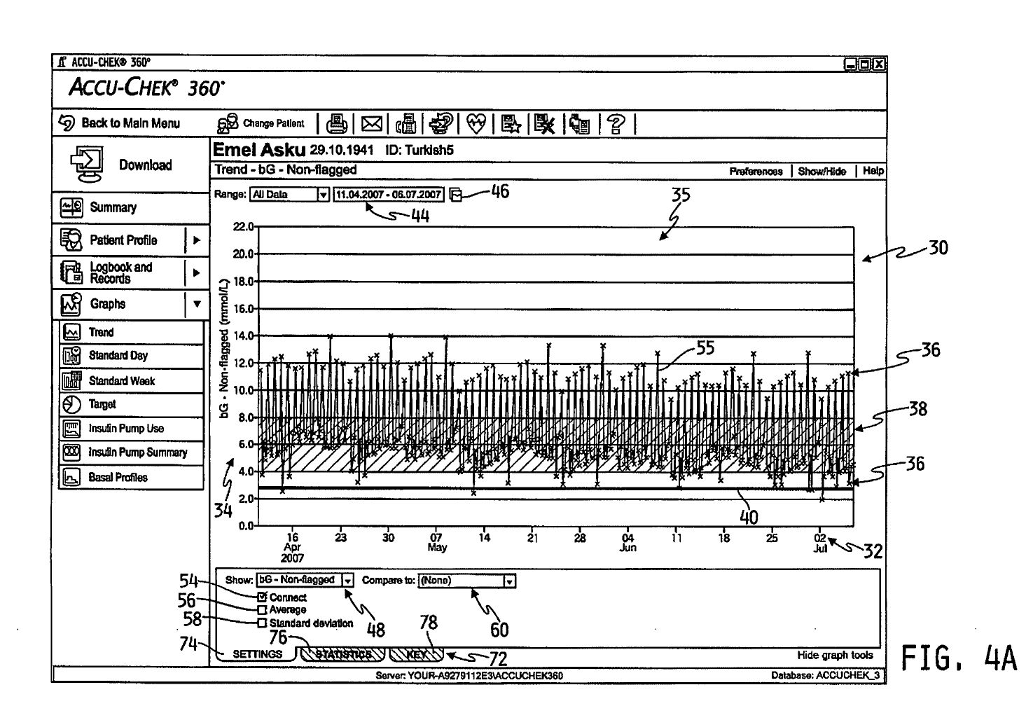

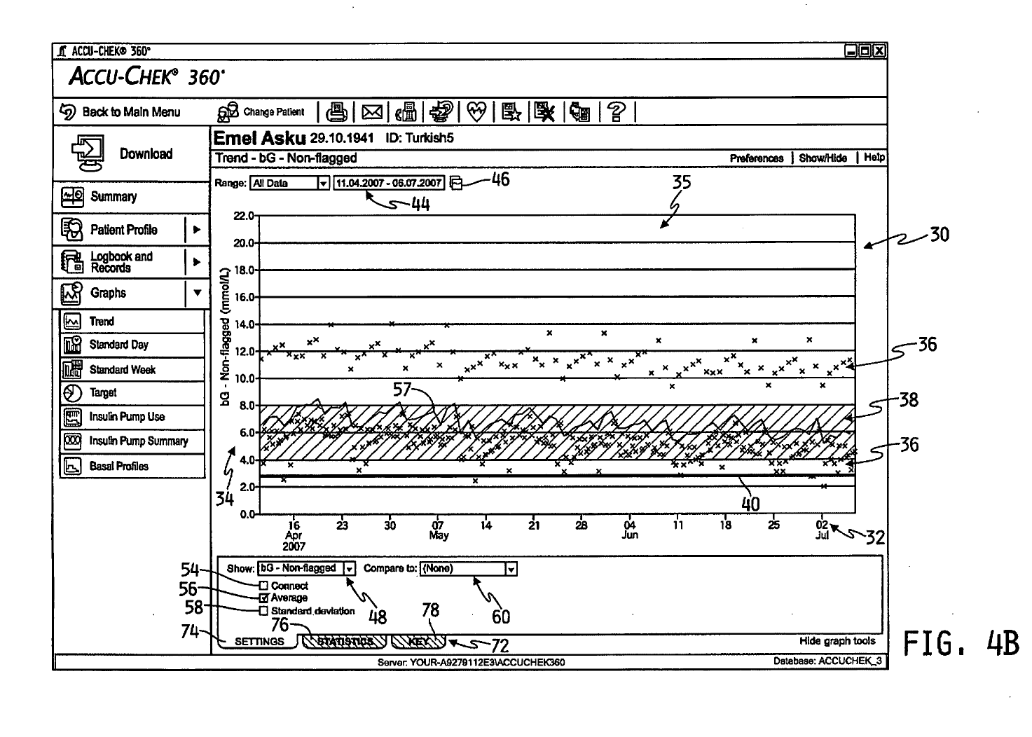

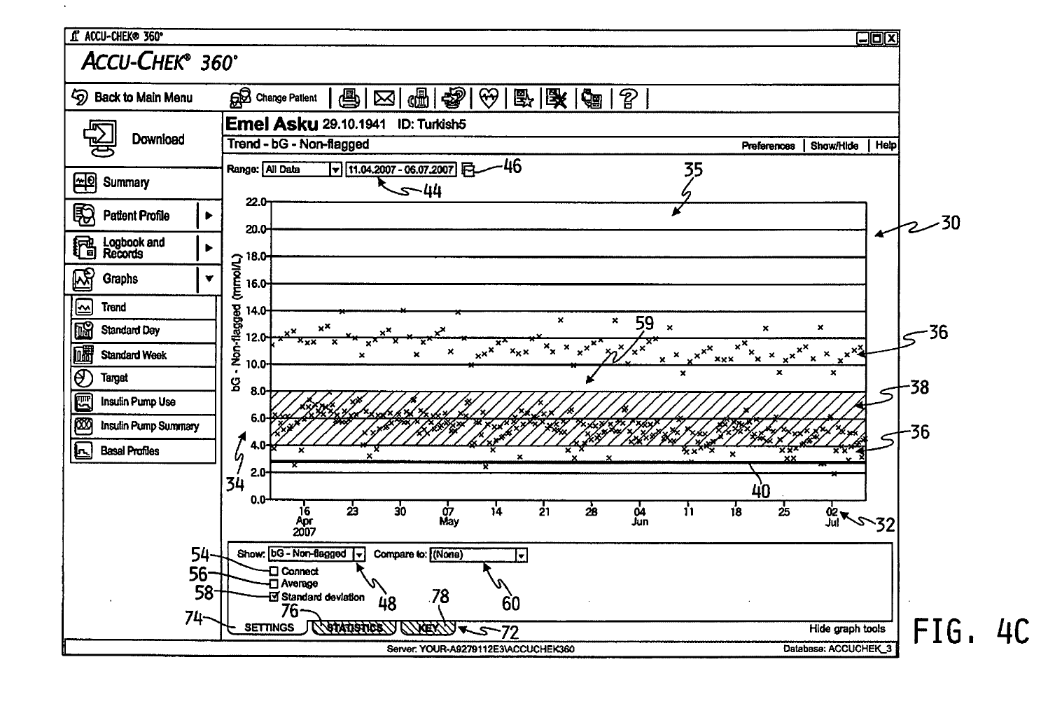

Once the user selects the graphs icon 26, the present embodiment of the invention presents the user with the screen capture depicted in FIG. 4. FIG. 4 includes a trend graph, generally indicated by numeral 30, charting blood glucose level versus time. In the depicted configuration, the trend graph 30 includes an x-axis 32, representing dates in a calendar year and a y-axis 34, representing blood glucose measurements. The x-axis 32 and the y-axis 34 define a display area 35 including a plurality of data points, generally indicated by numeral 36, corresponding to blood glucose measurements associated with the selected patient. In the depicted configuration, display area 35 further includes a desired blood glucose zone 38 and a hypoglycemic indicator line 40.

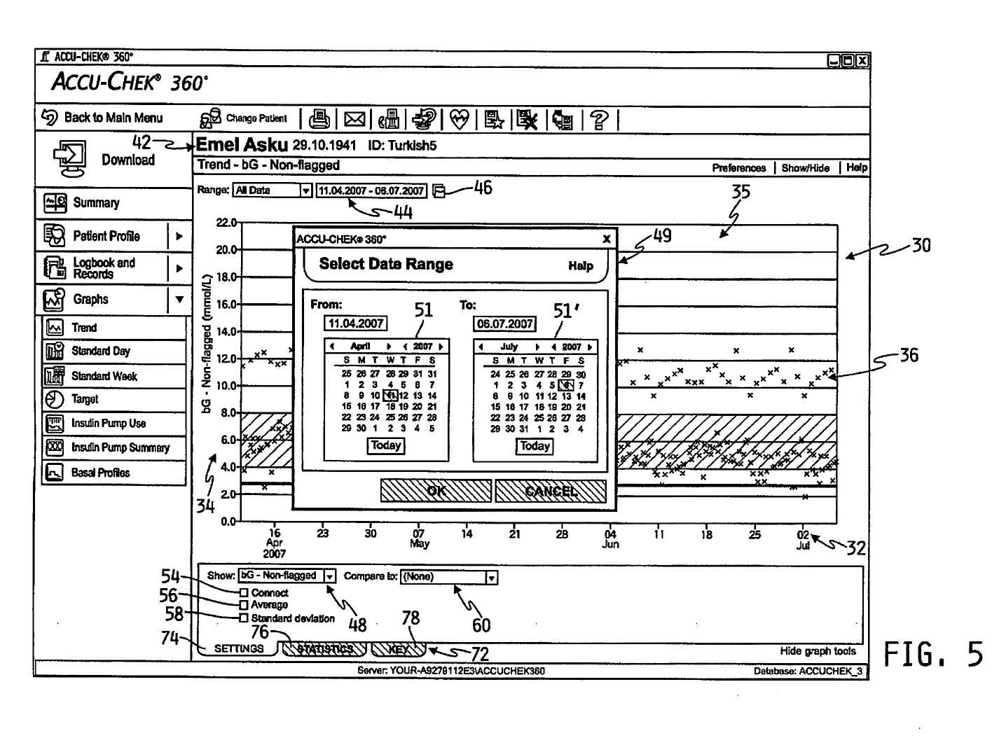

The name of the patient is displayed above graph 30 at 42. In addition, the date range of the data included in display area 35 is displayed in the box indicated by numeral 44. It should be noted that not all the data associated with the selected patient need be displayed in the display area 35. A subset of the data for the patient may be selected by date and displayed in the display area 35. For example, in the depicted embodiment, if the user selects the calendar icon 46, a date selection box indicated by numeral 49 in FIG. 5 will open. The user may then select the date range of the data to be displayed in a suitable manner. For example, on the first calendar 51, the user may select the beginning date for the date range, and the user may select the ending date of the date range on second calendar 51′.

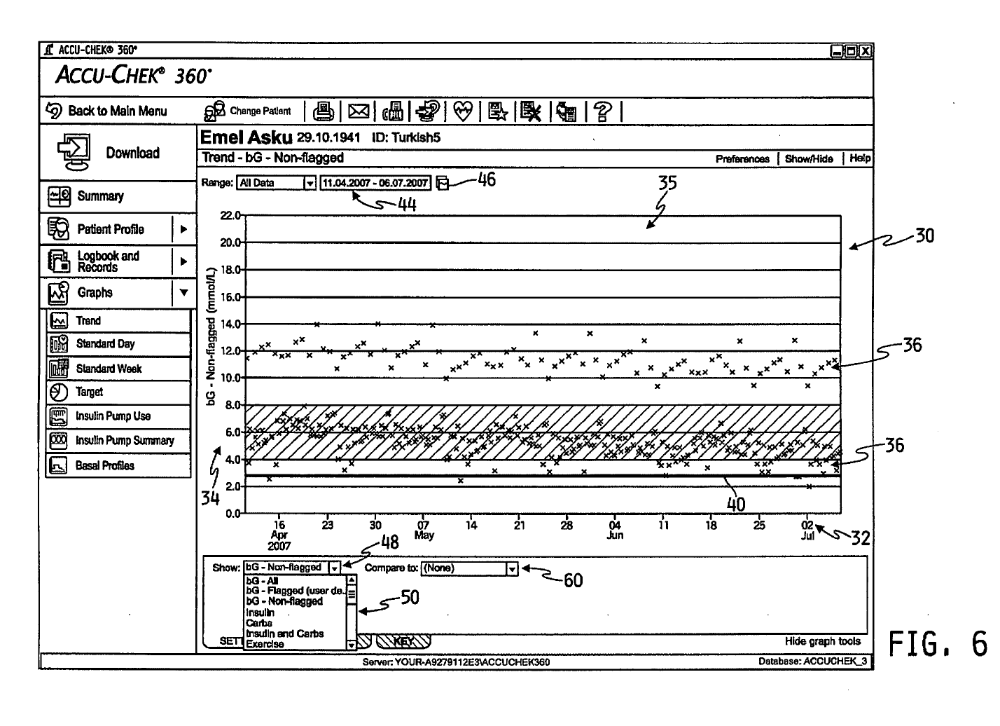

With respect again to FIG. 4, numeral 48 indicates a drop down menu. Drop down menu 48 provides the user with various choices as to the type of data associated with the selected patient that may be displayed on the graph. For example, FIG. 6 depicts a list of choices, generally indicated by numeral 50, that appear when the drop down menu 48 is selected by the user. The user may then select the type of information to be displayed on the graph from the list of choices provided.

Referring again to FIG. 4, the graph 30 includes a plurality of toggle buttons, generally indicated by numeral 52. In the depicted embodiment, the toggle buttons 52 include a toggle button 54 entitled “connect,” a toggle button 56 entitled “average” and a toggle button 58 entitled “standard deviation.” The toggle buttons 54, 56, 58 may be activated and deactivated in any suitable manner, such as by clicking a mouse, for example.

In the present embodiment, activating the “connect” toggle button 54 inserts a line 55 connecting all of the data points displayed on the display 35, as shown in FIG. 4A. Activating the “average toggle” button 56 adds a line 57 indicating the average of the data at any given time period to be added to the display area 35 as shown in FIG. 4B. Activation of the “standard deviation toggle” button 58 causes the display area 35 to display a shaded area 59 representing the standard deviation of the data being displayed on the display area 35., as shown FIG. 4C

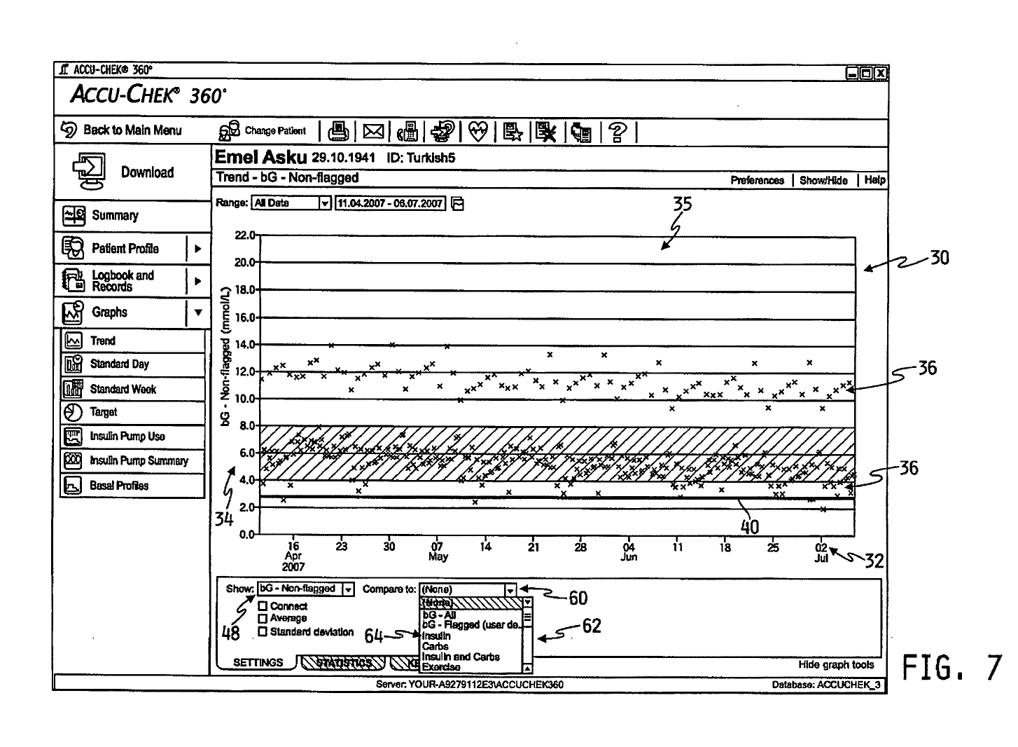

The graph 30 further includes a second drop down menu, generally indicated by numeral 60. Drop down menu 60 allows a user to compare two sets of data associated with the selected patient. For example, when the user clicks the drop down menu 60, the user is presented with a list of data, generally indicated by numeral 62, that may be added to the display area 35, as shown in FIG. 7. For example, a user may select insulin, indicated by numeral 64, in order to display insulin data on the display area 35 along with the blood glucose data.

For exemplary purposes, FIG. 8 depicts the graph 30 after the user has selected insulin 64. As seen in FIG. 8, drop down menu 60 now displays “insulin.” In addition, an additional y-axis, generally indicated by numeral 66, including data readings have been added to the graph 30. Numeral 68 indicates the insulin data associated with the selected patient, and numeral 70 generally indicates a toggle. Toggle 70 allows the user to determine which of the graphed data the user would like to emphasize or highlight. This comparison function is described in greater detail in and forms the basis of a corresponding U.S. Patent Application, entitled METHOD AND SYSTEM FOR DATA SELECTION AND DISPLAY, filed on even date herewith, the entire disclosure of which is expressly incorporated by reference herein.

With reference again to FIG. 4, the graph 30 includes a plurality of tabs, generally indicated by numeral 72. Tabs 72 include a settings tab 74, a statistic tab 76 and a key tab 78. The tabs 72 may be selected by the user in any conventional manner, such as by clicking. Settings tab 74 was selected in the foregoing description.

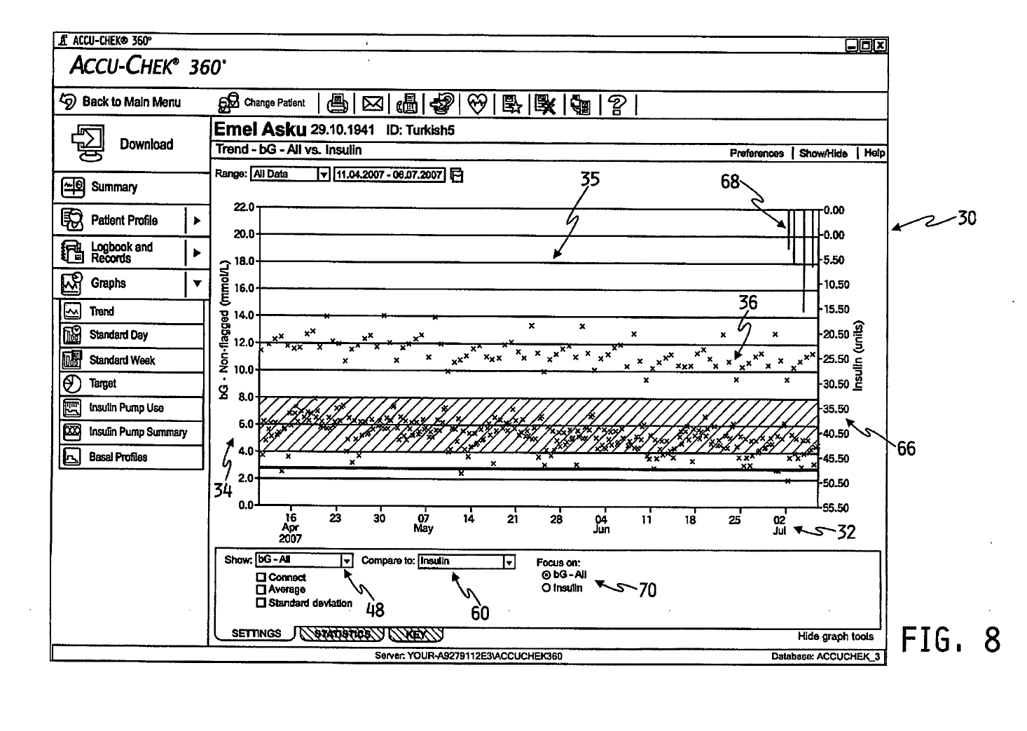

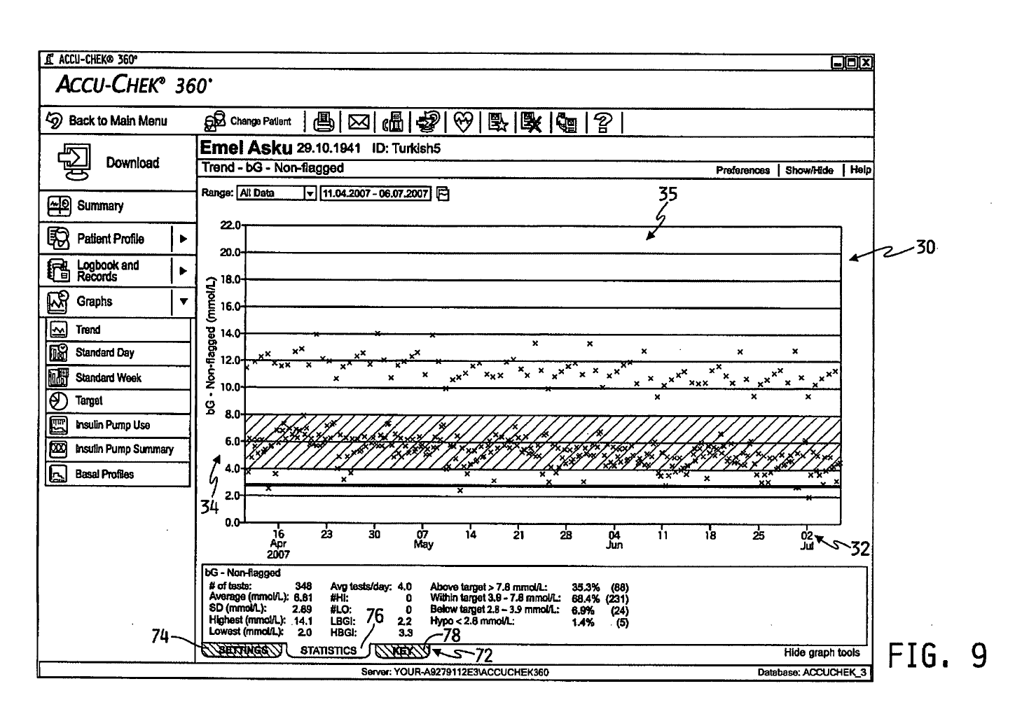

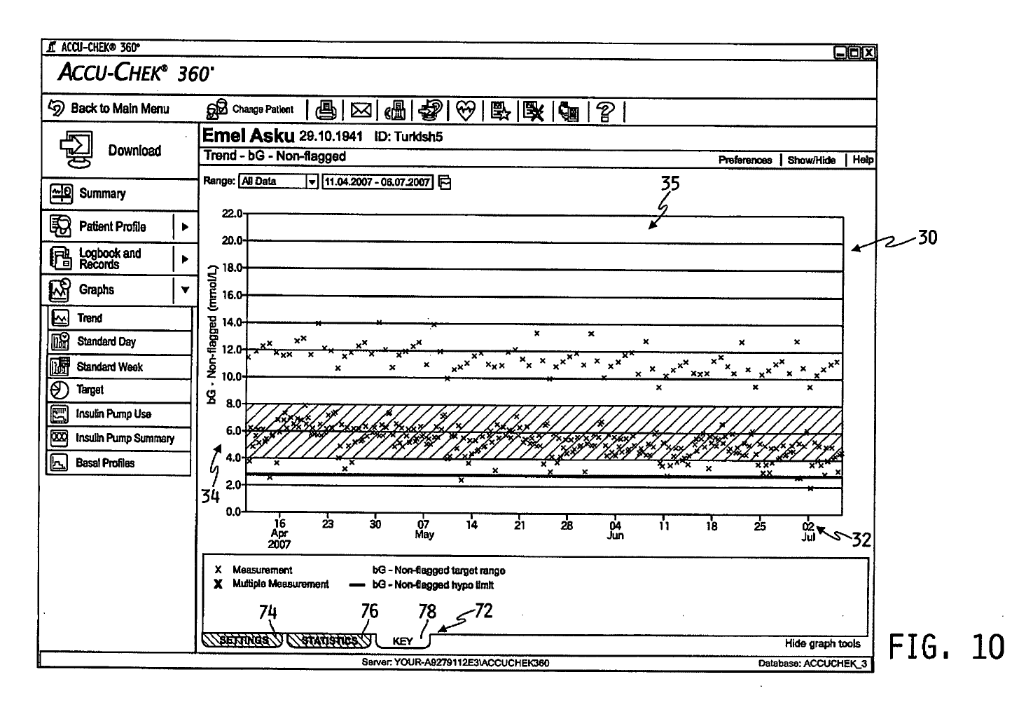

FIG. 9 generally illustrates the type of information that may be displayed when the statistics tab 76 is selected, and FIG. 10 generally illustrates the type of information that may be displayed when the key tab 78 is selected in the present embodiment. As seen in FIG. 9, in the depicted embodiment, when the statistics tab 76 is selected, statistics relating to the blood glucose level, such as the number of tests conducted, average blood glucose level, highest measurement, lowest measurement, etc., for example, are displayed below display area 35. As seen in FIG. 10, in the depicted embodiment, the key tab 78 provides a key for the information displayed on the display area 35. It should be noted that the information associated with these tabs 76, 78 may differ as other types of data are displayed on graph 30.

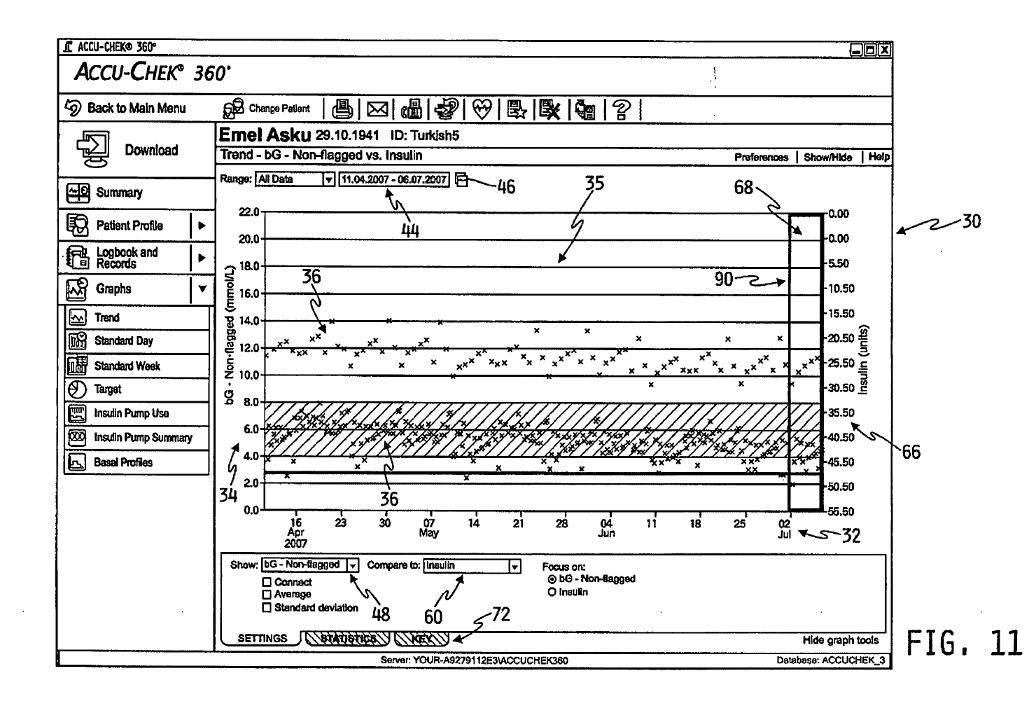

With reference now to FIG. 11, the depicted graph 30 includes data relating to blood glucose levels and insulin levels, as shown by the indications on the y-axes 34, 66 and the drop down menus 48, 60. When examining data, a user may desire to examine a subset of data, such as blood glucose levels associated with recorded insulin injections in greater detail. In this instance, the user may indicate the data that he or she desires to examine more closely. It should be noted that the user may indicate the desired data in any suitable manner. For example, in the depicted embodiment, the user may utilize a mouse connected to the computer running the software program to click and drag a border 90 over the data that the user would like to examine further.

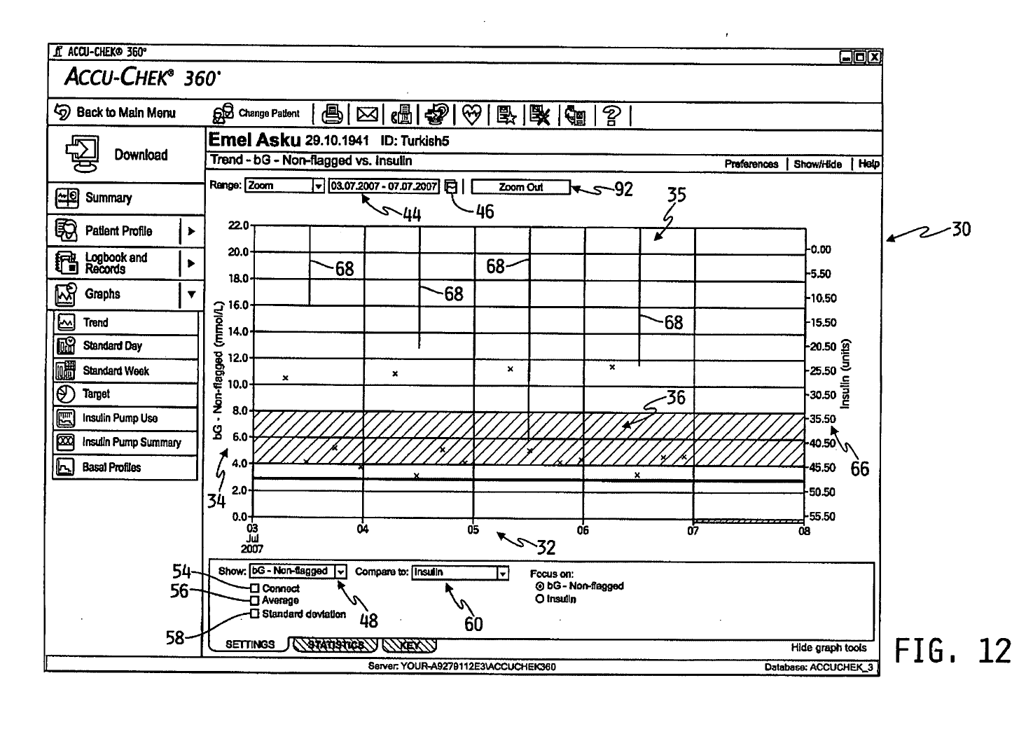

Once the user has indicated the data that the user would like to examine further, the data will be magnified automatically on the display area 35, as depicted in FIG. 12. In the present embodiment, substantially all of the data contained within border 90 of FIG. 11 is expanded to fill display area 35. Consequently, as can be seen in FIG. 12, the number of data points depicted in the display area 35 has been reduced. Similarly, the dates displayed on the x-axis 32 have been altered to correspond to the date range selected by the user. It should be noted that since the border 90 was arranged to cover substantially the entire range of the y-axes 34, 66, the values corresponding to the y-axes 34, 66 have not changed.

It should be noted that the dates listed in the date box 44 have changed in order to reflect the dates corresponding to the data depicted on the display area 35. Furthermore, the graph 30 now includes a “zoom out” icon, indicated by numeral 92.

If the user desires to further zoom in on the data depicted in the display area 35, the user may do so by creating another border 90 in the manner described above. Thus, for the depicted embodiment, the user may again click and drag a border over the data on which the user would like to zoom. Once the user has completed the examination of the data depicted on the display area 35, the user may click zoom out icon 92 in order to display all of the previous data in the display area 35.

It should be noted that after the user has zoomed in on a portion of the display area 35, all other functions continue to work in the manner in which they worked prior to zooming. For example, the user may utilize the toggle switches 54, 56, 58 to connect the data points, display an average line and/or display standard deviation lines. If the user zooms in on a portion of display area 35 that includes data exceeding the selected y-axis values 34, 66, the display area 35 may indicate that there exists data located outside of the zoomed display area 35 in any suitable manner, such as with an arrow, for example. Furthermore, it should also be noted that certain data points that have been combined into a single data point in the unmagnified display due to their proximity, may be depicted as two data points in the magnified display area 35.

The invention is described herein with reference to healthcare data management software, and more particularly, with reference to diabetes management software, although the invention may be applied, generally, to data management systems in fields unrelated to healthcare management.

While the invention is described herein with reference to medical devices, and more particularly, with reference to diabetes management devices, the invention is applicable to any data obtained from any device.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of magnifying a portion of a custom graph comprising the steps of:
plotting a first set of data on a graph including a display area;
selecting a portion of the graph to magnify; and
expanding the selected portion of the graph to substantially fill the display area.

2. The method as set forth in claim 1 further including the step of plotting a second set of data on the display area.

3. The method as set forth in claim 2 further including the step of selecting the type of data comprising the second set of data.

4. The method as set forth in claim 1 further including the step of selecting the type of data comprising the first set of data.

5. The method as set forth in claim 4 wherein the type of data includes blood glucose measurements.

6. The method as set forth in claim 1 further including the step of selecting a date range for the data to be plotted on the display area.

7. The method as set forth in claim 1 further including the step of selecting an icon in order to display the first data set in the display area without magnification.

8. The method as set forth in claim 1 further including the step of indicating with an indicator at least one data point of the first set of data that that is not depicted in the display area.

9. The method as set forth in claim 1 further including the step of plotting a pair of close data of the first set of data as a single data point.

10. The method as set forth in claim 9 further including the step of plotting the pair of close data of the first set of data as a pair of data points and the step of expanding the selected portion of the graph.

11. A method of displaying a first set of data on a graph including a display area, the method comprising the steps of:
selecting a date range in order to determine a subset of the first set of data;
plotting the subset of the first set of data on the display area;
selecting a portion of the display area; and
magnifying the selected portion of the display area to substantially fill the entire display area.

12. The method as set forth in claim 11 further comprising the step of selecting a first type of data comprising the first set of data.

13. The method as set forth in claim 12 further comprising the step of selecting a second type of data comprising the first set of data.

14. The method as set forth in claim 11 wherein a portion of the subset of the first set of data is plotted on the display area in the magnification step.

15. The method as set forth in claim 11 further comprising the step of plotting the entire subset of the first set of data in the display area following the magnifying step.

16. The method as set forth in claim 15 wherein the graph includes an icon configured to initiate the plotting of the entire subset of data step when the icon is selected.

17. The method as set forth in claim 11 wherein the step of selecting a date range includes the steps of:
selecting a beginning date from a first calendar; and
selecting an ending date from a second calendar.

18. The method as set forth in claim 11 wherein the first set of data is blood glucose data.

19. The method as set forth in claim 11 further including the step of plotting a subset of a second set of data.

20. The method as set forth in claim 19 wherein the subset of the second set of data depends upon the selected date range.

21. The method as set forth in claim 19 further including the step of selecting the type of data comprising the second set of data.

22. The method as set forth in claim 11 wherein the subset of the first set of data includes all of the first set of data.
